(19) United States
(12) Patent Application Publication
(10) Pub. No.: US 2014/0318096 A1
(43) Pub. Date: Oct. 30, 2014

(54) Active collection disposable lawn and leaf bag

(71) Applicants: Erik William Lukas, Jensen Beach, FL (US); Kirk Lukas, Cornwall, NY (US); John Lukas, Cornwall, NY (US)

(72) Inventors: Erik William Lukas, Jensen Beach, FL (US); Kirk Lukas, Cornwall, NY (US); John Lukas, Cornwall, NY (US)

(21) Appl. No.: 14/210,316

(22) Filed: Jul. 5, 2014

Related U.S. Application Data
(60) Provisional application No. 61/793,588, filed on Mar. 15, 2013.

(51) Int. Cl. A01D 43/063

(52) U.S. Cl. CPC A01D 43/0636
USPC 56/202

(57) ABSTRACT

Active collection disposable lawn and leaf bag is disclosed. Our invention makes disposing of grass and leaves a simple process of inserting a bag into a lawnmower bag and once the bag is full remove it (or removing the disposal bag from the connection device). Once removed you already have the grass and leaves for disposal in a bag for disposal.

This invention is associated with provisional patent application No. 61/793,588 Active collection disposable lawn and leaf bag. The applicant is Erik Lukas with joint inventors Kirk Lukas and John Lukas. Our invention makes disposing of grass and leaves a simple process of inserting a bag into a lawnmower bag and once the bag is full remove it (or removing the disposal bag from the connection device). Once removed you already have the grass and leaves for disposal in a bag for disposal.

### BACKGROUND OF THE INVENTION

Problem Solved: This invention solves the problem of having to take the time and effort in removing cut grass and leaves from a lawnmower's attached bag and put them into a lawn and leaf bag for disposal.

The problem with the current system is that it takes more effort and time. Often one has to place his hand and arm into a lawnmower bag to pull grass out and place it into another bag for disposal. Another issue is that there is time involved in moving the grass from the lawnmower bag to the disposal bag.

Our invention makes disposing of grass and leaves a simple process of inserting a bag into a lawnmower bag and once the bag is full remove it (or removing the disposal bag from the connection device). Once removed you already have the grass and leaves for disposal in a bag for disposal.

### DETAILED DESCRIPTION OF THE INVENTION

As stated above, the claim is that this invention solves the problem of having to take the time and effort in removing cut grass and leaves from a lawnmower's attached bag and put them into a lawn and leaf bag for disposal. The invention claimed here solves this problem.

This disposable bag is designed to be able to be inserted into a lawnmower bag and around the outside of the mouth of the bag or with an appropriate device connected behind the lawnmower and collect grass and leaves for disposal while mowing. It allows sufficient airflow to allow the bag to fill with cut grass and leaves. When the bag is full it remains small enough (insert version) to be removed from inside the lawnmower bag. This results in having the cut grass and leaves already being located in a bag for disposal.

The claimed invention differs from what currently exists. There are no existing bags that are designed to go into an existing lawnmower bag, allow airflow so the grass and leaves go into the bag, remain small enough to be removed from the lawnmower bag, and are designed to meet local regulations regarding bags to dispose of grass and leaves. Existing lawnmower bags are not designed to be used for collected lawn and leaf disposal inside the bag. They are bags for temporary collection and then removal to a disposal bag.

This invention is an improvement on what currently exists. Existing lawnmower bags are not designed to be used for collected lawn and leaf disposal inside the lawnmower bag itself. They are bags for temporary collection and then removal to a disposal bag. There are no existing bags that are designed to go into an existing lawnmower bag, allow airflow so the grass and leaves go into the bag, remain small enough to be removed from the lawnmower bag, and are designed to meet local regulations regarding bags to dispose of grass and leaves.

Although existing lawnmower bags function to have a place to keep cut grass, they do not make it very easy to dispose of the grass once cut.

A somewhat similar type of bag is used inside some indoor vacuums for collecting floor dirt. Where this invention differs from these bags is that those bags are made of a material that allows flow without holes. Material of this type does not lend itself to withstanding the force from sticks and rocks that will hit a lawnmower bag. Therefore we use thicker biodegradable paper or plastic that will withstand these forces in this application. This can result in back pressure preventing the bag from being filled adequately with grass. That is why we have a holed section to allow the airflow. Also, the materials in vacuum bags are not biodegradable which results in them not being able to be used in area where local governments require biodegradable lawn and leaf bags. In addition vacuum bags operate via requiring a seal around the tube that the vacuum is sucking the dirt and going into the bag. Our lawn and leaf bad does not require sealing to accomplish such a purpose, thereby being better design for its application. It is constrained externally, not internally like vacuum bag.

Our invention makes disposing of grass and leaves a simple process of inserting a bag into a lawnmower bag and once the bag is full remove it (or removing the disposal bag from the connection device). Once removed you already have the grass and leaves for disposal in a bag for disposal.

### The Version of The Invention Discussed Here Includes

A. Formed paper/plastic (See FIG. 1)

B. Holed section for air flow (See FIG. 1)

C. Lip that goes on the outside of the lawnmower bag (See FIG. 1)

D. Paper/rope/plastic loop for tying (See FIG. 1)

E. Optional Clamping/tying device(s) (See FIG. 4)

F. Optional mechanical attaching device (attach behind version) (See FIG. 4)

G. Optional glued in biodegradable holed section for air flow (See FIG. 2)

### Relationship Between The Components

The formed paper/plastic forms the main section of the bag that is inserted into a normal lawnmower bag where the grass and leaves will enter. The paper/rope/plastic loop is used to tie the bag once removed for disposal as well as an area to tighten the bag around the outside of the lawnmower bag while mowing. The paper/rope would go through a lip that goes outside the lawnmower's factory provided bags mouth. The holed paper/plastic is a section of the bag that allows airflow so the lawnmower functions normally moving cut grass and leaves into the bag. The air flow section can also be one big hole with a holed section glued in with biodegradable glue. This can be for cost or material benefits. The optional clamps/tying device is used to keep the mouth of the bag tightened around the outside of the mouth of the normal lawnmower bag so it remains in place while mowing. Any clamp, similar to clamps used to hold stacks of paper 50 pages or more can be used. An option would be to not use a clamping device but to temporarily tie the rope and untie to remove the bag. Another option is to keep the bag attached to a mechanical piece that is attached in place of the lawnmower bag for the behind version. The behind version would be where you do not insert the bag into the normal lawnmower bag but use it to replace the normal lawnmower bag itself. That would require a mechanical device to keep the bag constrained to the lawnmower, since that is normally done with the lawnmower bag. A clamping/tying area could be designed into the optional mechanical attaching device as well.

### How The Invention Works

Attach disposable bag into lawnmower bag for lawnmower in a fashion that allows the mouth to remain outside. Fold the lip area around the outside of the lawnmower bag avoiding the mechanisms that attach the lawnmower bag to the lawnmower (breaks in lip serve keep the lips from interfering with the mechanisms). Attach Clamp to keep bag tight around mouth (or tie rope tight). Attach lawnmower bag with disposable bag inside to lawnmower. Mow lawn. When disposable bag is full stop mowing. Remove disposable bag. Remove disposable bag. Tie bag. Dispose according to local regulations. For the behind version the process is the same with the exception that the method of attachment could be adjusted via attaching points to make keeping in place easier and more secure.

### How To Make The Invention

This invention is made using conventional manufacturing techniques for manufacturing paper or plastic bags. Paper bags would be cut as needed folded and glued together at key locations to form the shape of the bag. The section of paper or rope would be placed and folded into its proper place inside the lips prior to glue being used. The Plastic bags would be manufactured similar to trash bags, (one technique is to have pliable plastic blown into a large tube for forming) but would add a section after forming where strategic cutting would take place to allow airflow. (See FIG. 3 for example of plastic version.)

The optional parts are the clamping/tying device or mechanical attaching device (optionable depending on lawnmower bag and version). Another optional part would be to make the air flow section out of another material and glue it into a large hole in the bag. This would be for cost or material strength benefits. One improvement would be to have lawnmower bags come with attachment points on them for the disposable bags to keep them in place. Then the clamping/tying device would not be necessary. If the bag fits just right it could also stay in place without a clamping device.

A second improvement would be to add a mechanical attachment device as mentioned earlier that would fit the lawnmower or multiple lawnmowers, and attach the lawn and leaf bag behind. This would allow for using larger bags since you would not require them being able to both fit inside an existing lawnmower bag and remain small enough to remove.

### How To Use The Invention

Attach disposable bag into lawnmower bag for lawnmower in a fashion that allows the mouth to remain outside. Fold the mouth around the outside of the lawnmower bag. Attach Clamp to keep bag tight around mouth. Attach lawnmower bag with disposable bag inside to lawnmower. Mow lawn. When disposable bag is full stop mowing. Remove disposable bag. Remove disposable bag. Tie bag. Dispose according to local regulations. For the behind version the process is the same with the exception that the method of attachment could be adjusted via attaching points to make keeping in place easier and more secure.

Additionally: The device can be used in any situation where you need to collect items being moved by air power whose kinetic energy is small enough to not cut large holes in the bag causing loss of integrity or purpose.

### DESCRIPTION OF ATTACHED DRAWINGS

FIG. 1: This figure shows a top, front, rear, side and isometric view of a disposable active collection lawn and leaf bag made of paper with holes for air flow, lips, and a rope.

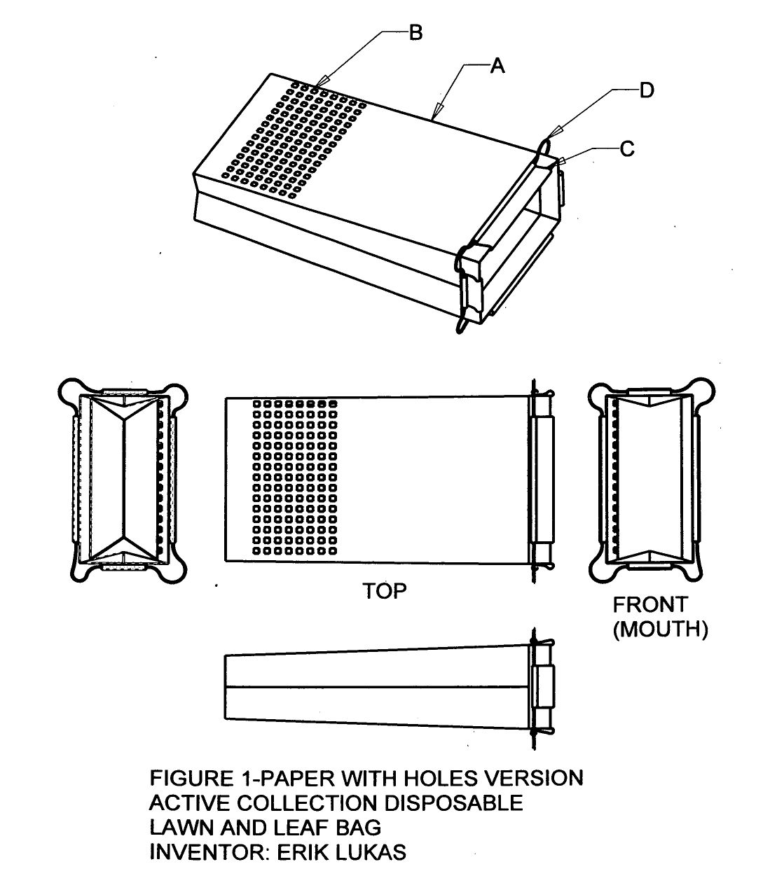

FIG. 2: This figure shows a top, front, side, and isometric view of a disposable active collection lawn and leaf bag with glued in holed portion for air flow instead of cut holes for airflow. It also is shown made of paper with lips and a rope.

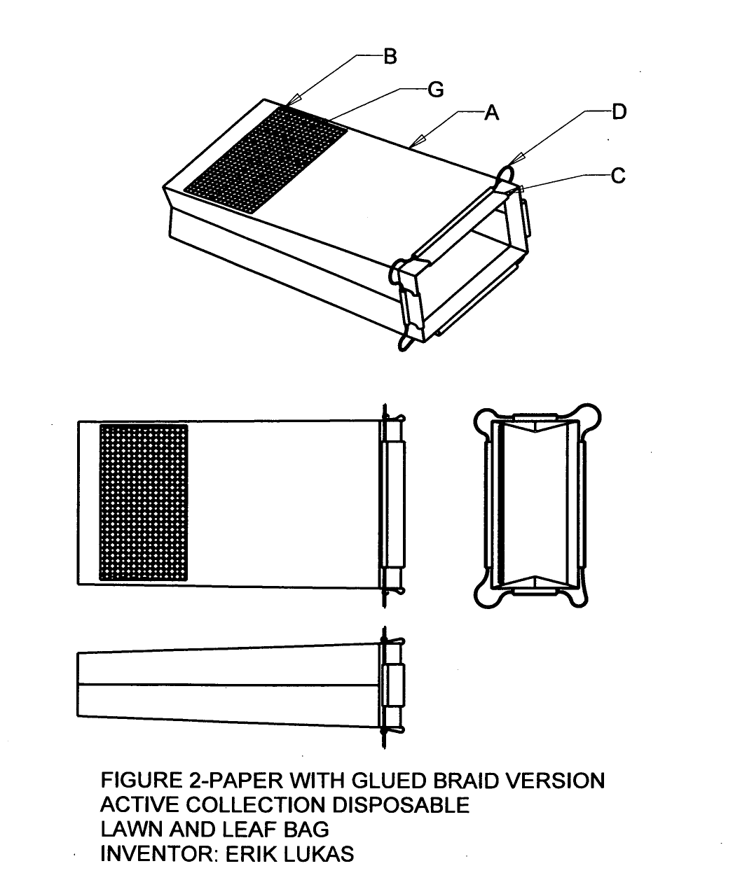

FIG. 3: This figure shows an isometric view of a disposable active collection lawn and leaf bag made of a biodegradable plastic material. It contains holes for air flow, a lip, and plastic portion for tying.

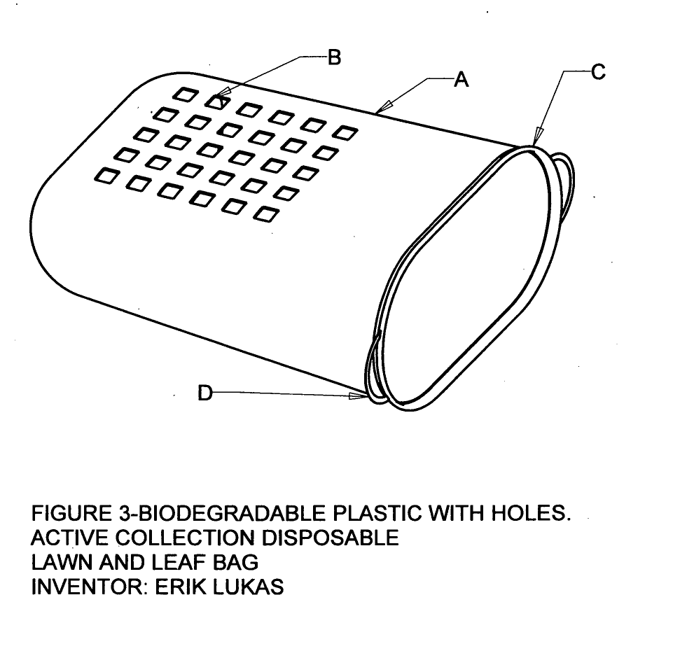

FIG. 4: This figure shows an active collection lawn and leaf bag attached to a mechanical device (not part of this disclosure) for attaching to the lawnmower in lieu of placing inside of a normal lawnmower bag. It displays the optional tying device to maintain bag position while collecting grass and leaves.

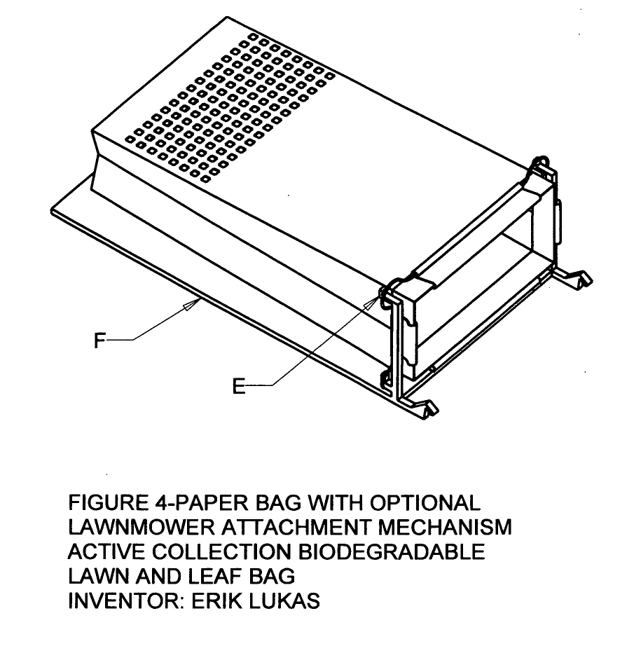

1. This invention solves the problem of having to take the time and effort in removing cut grass and leaves from a lawnmower's attached bag and put them into a lawn and leaf bag for disposal. The invention claimed here solves this problem.
This disposable bag is designed to be able to be inserted into a lawnmower bag and around the outside of the mouth of the bag or with an appropriate device connected behind the lawnmower and collect grass and leaves for disposal while mowing. It allows sufficient airflow to allow the bag to fill with cut grass and leaves. When the bag is full it remains small enough (insert version) to be removed from inside the lawnmower bag. This results in having the cut grass and leaves already being located in a bag for disposal.
In order to achieve the claim we designed a bag that is disposable, fits into an existing lawnmower bag attached to a lawnmower (or can be attached via a separate attachment device not part of this disclosure), allows sufficient air flow to collect cut grass and leaves, and then can be removed for immediate disposal without the need for manually removing the cut grass and leaves into a separate disposal bag.
